(19) United States
(12) Patent Application Publication
(10) Pub. No.: US 2020/0349267 A1
(43) Pub. Date: Nov. 5, 2020

(54) SHREDDING SYSTEM AND METHOD

(71) Applicant: EMC IP Holding Company, LLC, Hopkinton, MA (US)

(72) Inventor: VICTOR SALAMON, Edmonton (CA)

(21) Appl. No.: 15/492,555

(22) Filed: Apr. 20, 2017

(51) Int. Cl. G06F 21/60; G06F 21/64; H04L 29/06

(52) U.S. Cl. CPC G06F 21/604; H04L 63/0876; G06F 21/64

(57) ABSTRACT

A method, computer program product, and computing system for maintaining an application stack for use within a virtualized space. A shredding process is effectuated on the application stack.

### TECHNICAL FIELD

This disclosure relates to shredding systems and methods and, more particularly, to shredding systems and methods for use within a virtualized environment.

### BACKGROUND

Storing and safeguarding electronic content is of paramount importance in modern business. Accordingly, various methodologies may be employed to protect and distribute such electronic content. For example, high-availability, virtualized storage systems may be utilized to provide users with access to virtual machines (and associated virtualized storage) that may be custom tailored to the needs and desires of the user. Unfortunately and when utilizing such virtualized systems, safeguards should be employed to prevent unauthorized access to the same.

### SUMMARY OF DISCLOSURE

In one implementation, a computer-implemented method is executed on a computing system and includes maintaining an application stack for use within a virtualized space. A shredding process is effectuated on the application stack.

One or more of the following features may be included. The shredding process may be effectuated in response to one or more of: a manual command; and an occurrence of a security trigger event. The application stack may include one or more of: a virtual machine operating environment; a virtual machine; virtual storage; physical storage; user applications; OS bytecode; configuration data; user data; and utilities. The trigger event may include: a failure of a heartbeat signal to be received within the virtualized space. The trigger event may include: a changing of a unique identifier associated with a host of the virtualized space. The trigger event may include: a failure of a host of the virtualized space to be included on a whitelist of hosts. The trigger event may include: a failure to authenticate with a host of the virtualized space.

In another implementation, a computer program product resides on a computer readable medium and has a plurality of instructions stored on it. When executed by a processor, the instructions cause the processor to perform operations including maintaining an application stack for use within a virtualized space. A shredding process is effectuated on the application stack.

One or more of the following features may be included. The shredding process may be effectuated in response to one or more of: a manual command; and an occurrence of a security trigger event. The application stack may include one or more of: a virtual machine operating environment; a virtual machine; virtual storage; physical storage; user applications; OS bytecode; configuration data; user data; and utilities. The trigger event may include: a failure of a heartbeat signal to be received within the virtualized space. The trigger event may include: a changing of a unique identifier associated with a host of the virtualized space. The trigger event may include: a failure of a host of the virtualized space to be included on a whitelist of hosts. The trigger event may include: a failure to authenticate with a host of the virtualized space.

In another implementation, a computing system includes a processor and a memory system configured to perform operations including maintaining an application stack for use within a virtualized space. A shredding process is effectuated on the application stack.

One or more of the following features may be included. The shredding process may be effectuated in response to one or more of: a manual command; and an occurrence of a security trigger event. The application stack may include one or more of: a virtual machine operating environment; a virtual machine; virtual storage; physical storage; user applications; OS bytecode; configuration data; user data; and utilities. The trigger event may include: a failure of a heartbeat signal to be received within the virtualized space. The trigger event may include: a changing of a unique identifier associated with a host of the virtualized space. The trigger event may include: a failure of a host of the virtualized space to be included on a whitelist of hosts. The trigger event may include: a failure to authenticate with a host of the virtualized space.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a storage system and a storage management process coupled to a distributed computing network;

FIG. 2 is a diagrammatic view of an implementation of the storage system of FIG. 1;

FIG. 3 is a diagrammatic view of another implementation of the storage system of FIG. 1 including a security process;

FIG. 4 is virtualized view of the storage system of FIG. 3; and

FIG. 5 is a flow chart of the shredding process of FIG. 3.

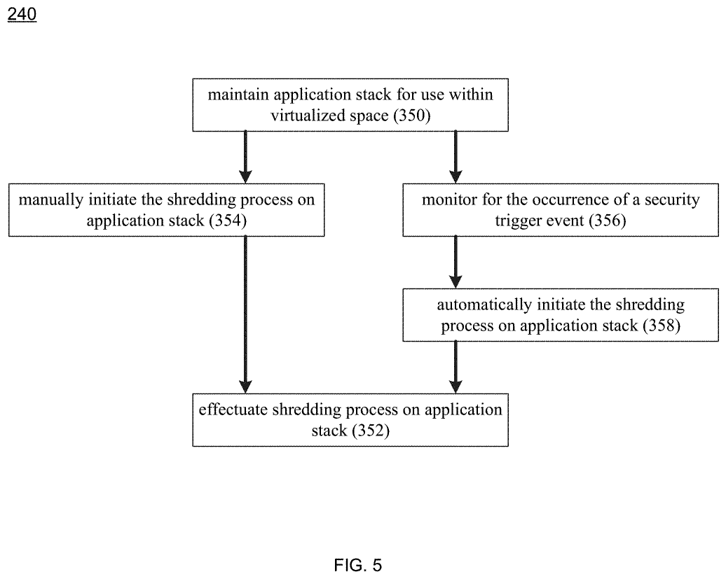

Like reference symbols in the various drawings indicate like elements.

### DETAILED DESCRIPTION OF THE PREFERRED EMBODIMENTS

### System Overview

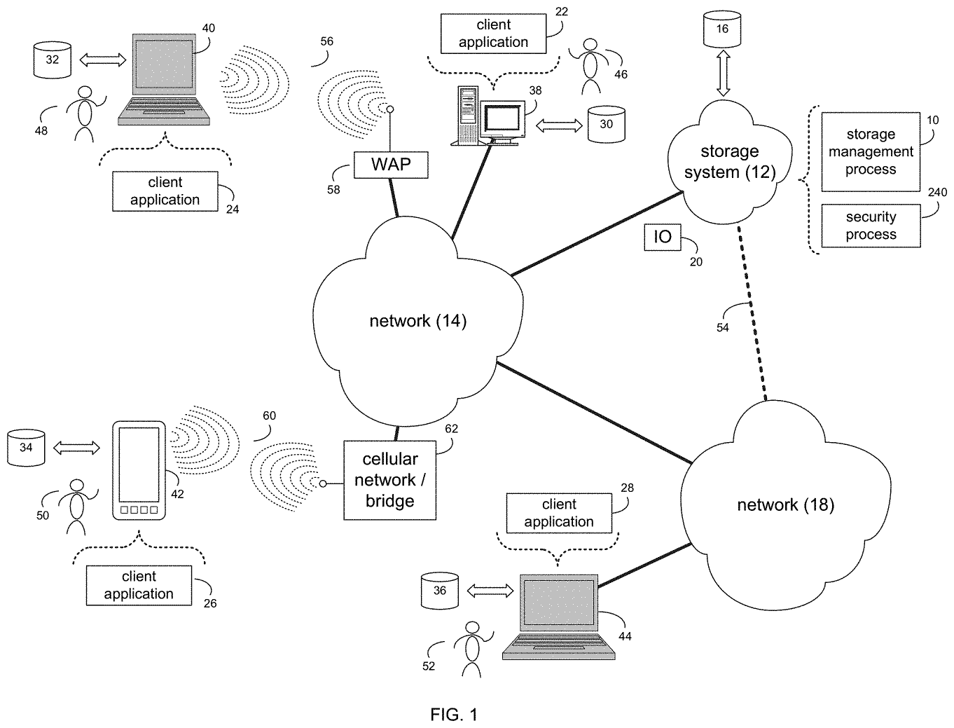

Referring to FIG. 1, there is shown storage management process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft Windows 2003 Server™; Redhat Linux™, Unix, or a custom operating system, for example.

The instruction sets and subroutines of storage management process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Various 10 requests (e.g. 10 request 20) may be sent from client applications 22, 24, 26, 28 to storage system 12. Examples of 10 request 20 may include but are not limited to data write requests (i.e. a request that content be written to storage system 12) and data read requests (i.e. a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft Windows™, Apple Macintosh™, Redhat Linux™, or a custom operating system.

For illustrative purposes, storage system 12 will be described as being a network-based storage system that includes a plurality of backend storage devices. However, this is for illustrative purposes only and is not intended to be a limitation of this disclosure, as other configurations are possible and are considered to be within the scope of this disclosure.

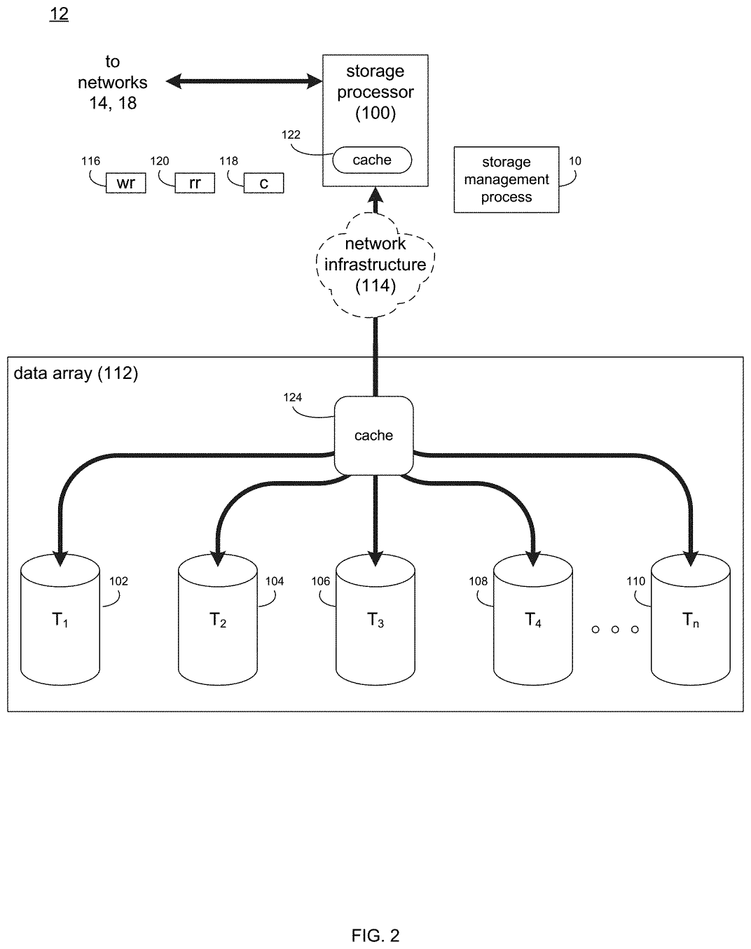

Referring also to FIG. 2, there is shown one particular implementation of storage system 12. Storage system 12 may include storage processor 100 and a plurality of storage targets T 1-n (e.g. storage targets 102, 104, 106, 108, 110). Storage targets 102, 104, 106, 108, 110 may be configured to provide various levels of performance and/or high availability. For example, one or more of storage targets 102, 104, 106, 108, 110 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108, 110 may be configured as a RAID 1 array, in which data is mirrored between storage targets. By mirroring data between storage targets, a level of high availability is achieved as multiple copies of the data are stored within storage system 12.

While storage targets 102, 104, 106, 108, 110 are discussed above as being configured in a RAID 0 or RAID 1 array, this is for illustrative purposes only and is not intended to be a limitation of this disclosure, as other configurations are possible. For example, storage targets 102, 104, 106, 108, 110 may be configured as a RAID 3, RAID 4, RAID 5 or RAID 6 array.

While in this particular example, storage system 12 is shown to include five storage targets (e.g. storage targets 102, 104, 106, 108, 110), this is for illustrative purposes only and is not intended to be a limitation of this disclosure. Specifically, the actual number of storage targets may be increased or decreased depending upon e.g. the level of redundancy/performance/capacity required.

One or more of storage targets 102, 104, 106, 108, 110 may be configured to store coded data. As is known in the art, coded data may allow for the regeneration of data lost/corrupted on one or more of storage targets 102, 104, 106, 108, 110.

Examples of storage targets 102, 104, 106, 108, 110 may include one or more electro-mechanical hard disk drives and/or one or more solid-state/flash devices, wherein a combination of storage targets 102, 104, 106, 108, 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108, 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108, 110 may be a RAID device and/or computer-based hard disk drives. Further still, one or more of storage targets 102, 104, 106, 108, 110 may be a SAN.

In the event that storage system 12 is configured as a SAN, the various components of storage system 12 (e.g. storage processor 100, storage targets 102, 104, 106, 108, 110) may be coupled using network infrastructure 114, examples of which may include but are not limited to an Ethernet (e.g., Layer 2 or Layer 3) network, a fiber channel network, an InfiniBand network, or any other circuit switched/packet switched network.

### The Storage Management Process

Storage system 12 may execute all or a portion of storage management process 10. The instruction sets and subroutines of storage management process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random access memory (RAM); a read-only memory (ROM); and all forms of flash memory storage devices. Additionally, some or all of the instruction sets and subroutines of storage management process 10 may be executed by one or more processors (not shown) and one or more memory architectures (not shown) included within data array 112.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (i.e. a request that content 118 be written to storage system 12) and data read request 120 (i.e. a request that content 118 be read from storage system 12).

During operation of storage processor 100, content 118 to be written to storage system 12 may be processed by storage processor 100 and storage management process 10. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 and storage management process 10 may initially store content 118 within frontend cache memory system 122. Depending upon the manner in which frontend cache memory system 122 is configured, storage processor 100 and storage management process 10 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 and storage management process 10 may initially store content 118 within backend cache memory system 124 prior to being stored on e.g. one or more of storage targets 102, 104, 106, 108, 110.

### A Virtualized Environment

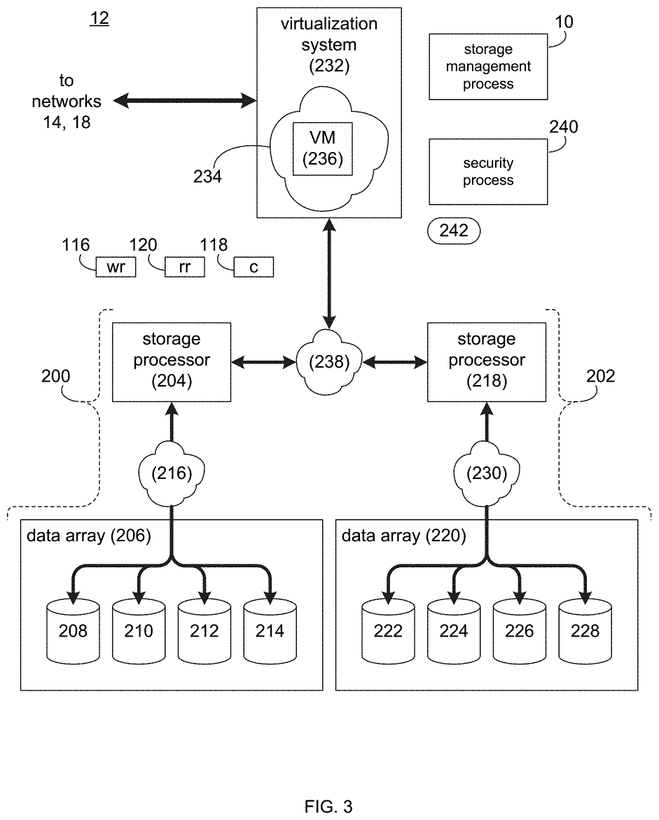

Referring also to FIG. 3, there is shown another implementation of storage system 12 that may include multiple storage subsystems (e.g., subsystems 200, 202). For illustrative purposes only, the first subsystem (e.g., subsystem 200) is shown to include a first storage processor (e.g., storage processor 204) coupled to a first data array (e.g., data array 206) that includes storage targets 208, 210, 212, 214, which may be coupled using network infrastructure 216, examples of which may include but are not limited to an Ethernet (e.g., Layer 2 or Layer 3) network, a fiber channel network, an InfiniBand network, or any other circuit switched/packet switched network.

Further and for illustrative purposes only, the second subsystem (e.g., subsystem 202) is shown to include a second storage processor (e.g., storage processor 218) coupled to a second data array (e.g., data array 220) that includes storage targets 222, 224, 226, 228, which may be coupled using network infrastructure 230, examples of which may include but are not limited to an Ethernet (e.g., Layer 2 or Layer 3) network, a fiber channel network, an InfiniBand network, or any other circuit switched/packet switched network.

While this implementation of storage system 12 is shown to include two subsystems (e.g., subsystem 200 and subsystem 202), this is for illustrative purposes only and is not intended to be a limitation of this disclosure. For example, the number of subsystems may be increased or decreased depending upon the needs of the user and/or design criteria.

Further and while this implementation of storage system 12 is shown to include subsystems (e.g., subsystem 200 and subsystem 202) that each include four storage targets each (e.g., subsystem 200 having storage targets 208, 210, 212, 214; and subsystem 202 having storage targets 222, 224, 226, 228), this is for illustrative purposes only and is not intended to be a limitation of this disclosure. For example, the number of storage targets may be increased or decreased depending upon the needs of the user and/or design criteria.

Storage system 12 may further include virtualization system 232 (e.g., a virtualization appliance) that may allow for seamless access to one or both of subsystems 200, 202. Specifically, virtualization system 232 may execute virtual machine operating environment 234. An example of virtual machine operating environment 234 may include but is not limited to a hypervisor, which is an instantiation of an operating system that may allow for one or more virtual machines (e.g., virtual machine 236) to operate within a single physical device. Accordingly, the combination of virtualization system 232, virtual machine operating environment 234, and virtual machine 236 may allow one or more users to access the resources of subsystems 200, 202. Virtualization system 232, subsystem 200 and subsystem 202 may be coupled using network infrastructure 238, examples of which may include but are not limited to an Ethernet (e.g., Layer 2 or Layer 3) network, a fiber channel network, an InfiniBand network, or any other circuit switched/packet switched network.

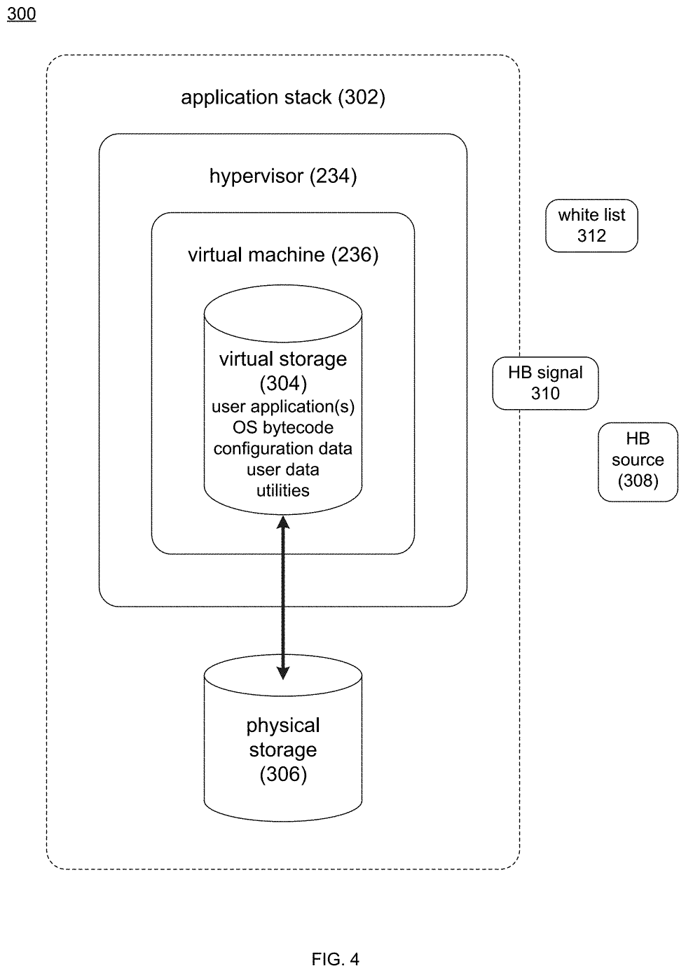

Referring also to FIG. 4, when effectuating a virtualized space 300, an application stack (e.g., application stack 302) may be generated that may include various components (both virtual components and physical components) that may be required to effectuate virtualized space 300, examples of which may include but are not limited to: the virtual machine operating environment (e.g., hypervisor 234), the virtual machine itself (e.g., virtual machine 236), the virtualized storage (e.g., virtualized storage 304, which is the virtualized portion of storage that is presented to the user of virtualized space 300), and the underlying physical storage (e.g., the physical storage 306 from which virtualized storage 304 may be assembled).

Within virtual machine 236 and virtualized storage 304, user application(s), operating system (OS) bytecode, configuration data, user data and/or utilities may be executed and/or stored (respectively). For example, if application stack 302 emulates a Windows™ operating environment, virtual machine 236 may utilize Windows™ OS bytecode that may be stored on virtualized storage 304. Further, if application stack 302 includes a database application, this user application may be executed by virtual machine 236 and may be stored on virtualized storage 304. Additionally, application stack 302 may include configuration data that may define one of more configuration parameters/details for virtualized space 300 that may be defined/processed by virtual machine 236 and may be stored on virtualized storage 304. Further, application stack 302 may include user data that may be generated on virtual machine 236 by the user applications (e.g., the database application) and may be stored on virtualized storage 304. Additionally, application stack 302 may include one or more utilities that may be executed by virtual machine 236, may be stored on virtualized storage 304, and may perform one or more utilitarian functions (e.g., such as housekeeping functions within virtualized space 300 and security functions within virtualized space 300).

As discussed above, physical storage 306 may be the physical storage space from which virtualized storage 304 may be assembled. As also discussed above and in this example, first data array (e.g., data array 206) may include storage targets 208, 210, 212, 214 and second data array (e.g., data array 220) may include storage targets 222, 224, 226, 228). Accordingly, physical storage 306 associated with virtualized storage 304 may be portions of one or more of storage targets 208, 210, 212, 214, 222, 224, 226, 228

### The Security Process

Storage system 12 may execute all or a portion of security process 240. The instruction sets and subroutines of security process 240, which may be stored on a storage device (e.g., storage device 16) coupled to storage system 12, may be executed by one or more processors (not shown) and one or more memory architectures (not shown) included within any portion, system and/or subsystem of storage system 12. Storage device 16 may include but is not limited to: a hard disk drive; a tape drive; an optical drive; a RAID device; a random access memory (RAM); a read-only memory (ROM); and all forms of flash memory storage devices.

During operation of storage system 12, security process 240 (alone or in combination with storage management process 10) may maintain 350 application stack 302 for use within virtualized space 300. For example, a user of storage system 12 (e.g., user 46) may request a virtualized space (e.g., virtualized space 300) that includes a database application and a defined quantity of storage.

Accordingly, storage management process 10 may generate the above-described application stack 302 (e.g., which may include hypervisor 234, virtual machine 236, virtualized storage 304, and physical storage 306. As discussed above and within virtual machine 236 and virtualized storage 304, user application(s), operating system (OS) bytecode, configuration data, user data and/or utilities may be executed and/or stored (respectively).

Once application stack 302 is generated, security process 240 (alone or in combination with storage management process 10) may maintain 350 application stack 302 for use within virtualized space 300. For various reasons to be discussed below, security process 240 may effectuate 352 a shredding process on application stack 302.

As is known in the art, a shredding process is a data destruction method that is designed to securely erase data storage devices. Shredding processes may utilize an overwrite methodology to ensure complete destruction of the data. For example and as is known in the art, when data is deleted in a traditional fashion, the computing system does not actually delete the data and simply marks the data as no longer needed. Accordingly, the data is still on the storage device and the only thing that is deleted is the pointer within the operating system that locates the data. However, the data itself is still located on the storage device. Since the actual data is still resident on the storage device, it is typical possible to recover the data using one or more data recovery utilities (e.g., Recuva™ and Puran™). Unlike a traditional erase operation, a shredding process may overwrite the data that was deleted one or more times (typically 3-7 times), thus completely destroying the deleted data on the storage device and making it unrecoverable.

The above-described shredding process on application stack 302 may be effectuated 352 in response to a manual command or an occurrence of a security trigger event.

For example, assume that the project that user 46 was working on has been completed and virtualized space 300 is no longer needed. Accordingly, user 46 may store/archive the work product produced by this project and may then manually initiate 354 the above-described shredding process on application stack 302. Therefore, hypervisor 234, virtual machine 236, virtualized storage 304, and physical storage 306 may all be shredded, including the user application(s), the operating system (OS) bytecode, the configuration data, the user data and/or the utilities that are executed by and/or stored on virtual machine 236 and/or virtualized storage 304 (respectively).

Additionally/alternatively, security process 240 may monitor 356 for the occurrence of a security trigger event (e.g., security trigger event 242). And in the event that a security trigger event (e.g., security trigger event 242) is detected, security process 240 may automatically initiate 358 the above-described shredding process on application stack 302.

Security trigger event 242 may be generated in response to an event or situation that indicates that the security of virtualized space 300 and/or application stack 302 has been compromised. Examples of security trigger event 242 may include but are not limited to: a) a failure of a heartbeat signal to be received within virtualized space 300; b) a changing of a unique identifier associated with a host (e.g., virtualization system 232) of virtualized space 300; c) a failure of a host (e.g., virtualization system 232) of virtualized space 300 to be included on a whitelist of hosts; and d) a failure to authenticate with a host (e.g., virtualization system 232) of virtualized space 300.

### Failure of a Heartbeat Signal to be Received within Virtualized Space

A heartbeat source (e.g., HB source 308) may periodically generate and broadcast a heartbeat signal (e.g., heartbeat signal 310), wherein heartbeat signal 310 would be received by virtualized space 300 and/or application stack 302. Typically, HB source 308 is an external source. For example, HB source 308 may be effectuated by/included within e.g., a storage processor (e.g., storage processor 204, 218) or virtualization system 232. Accordingly, virtualized space 300 and/or application stack 302 should receive heartbeat signal 310 at predefined intervals (e.g., once per second, once per minute, once per hour, etc.). And in the event that virtualized space 300 and/or application stack 302 does not receive heartbeat signal 310 for a predefined period of time (e.g., a minute, an hour, a day, etc.), this may be indicative of virtualized space 300 and/or application stack 302 being compromised (e.g., stolen and copied onto an unauthorized system and/or removed or isolated from authorized external hardware and systems).

Accordingly and in such a situation, security trigger event 242 may be generated and security process 240 may automatically initiate 358 the above-described shredding process on application stack 302. Therefore, hypervisor 234, virtual machine 236, virtualized storage 304, and physical storage 306 may all be shredded, including the user application(s), the operating system (OS) bytecode, the configuration data, the user data and/or the utilities that are executed by and/or stored on virtual machine 236 and/or virtualized storage 304 (respectively).

### Changing of a Unique Identifier Associated with a Host

Virtualized space 300 and/or application stack 302 may be effectuated via a host (e.g., virtualization system 232), examples of which may include but are not limited to a virtualization appliance. Each host may be defined using a unique identifier, such as a World Unique Identify Number or a MAC address. Further and when configuring virtualized space 300 and/or application stack 302, the unique identifier associated with this host (e.g., virtualization system 232) may be stored within virtualized space 300 and/or application stack 302. Security process 240 may periodically check to confirm that the unique identifier stored within virtualized space 300 and/or application stack 302 matches the unique identifier of the host (e.g., virtualization system 232).

And in the event that the unique identifier stored within virtualized space 300 and/or application stack 302 does not matches the unique identifier of the host (e.g., virtualization system 232), this may be indicative of virtualized space 300 and/or application stack 302 being compromised (e.g., stolen and copied onto an unauthorized system and/or removed or isolated from authorized external hardware and systems).

Accordingly and in such a situation, security trigger event 242 may be generated and security process 240 may automatically initiate 358 the above-described shredding process on application stack 302. Therefore, hypervisor 234, virtual machine 236, virtualized storage 304, and physical storage 306 may all be shredded, including the user application(s), the operating system (OS) bytecode, the configuration data, the user data and/or the utilities that are executed by and/or stored on virtual machine 236 and/or virtualized storage 304 (respectively).

### Failure of a Host to be Included on a Whitelist

As discussed above, virtualized space 300 and/or application stack 302 may be effectuated via a host (e.g., virtualization system 232), examples of which may include but are not limited to a virtualization appliance, wherein each host may be defined using a unique identifier, such as a World Unique Identify Number or a MAC address. The unique identifier associated with this host (e.g., virtualization system 232) may be included within a white list (e.g., white list 312) that identifies authorized hosts/hardware/platforms. Security process 240 may periodically check to confirm that the unique identifier associated with this host (e.g., virtualization system 232) is included within white list 312.

In the event that the unique identifier associated with this host (e.g., virtualization system 232) is not included within white list 312, this may be indicative of virtualized space 300 and/or application stack 302 being compromised (e.g., stolen and copied onto an unauthorized system and/or removed or isolated from authorized external hardware and systems).

Accordingly and in such a situation, security trigger event 242 may be generated and security process 240 may automatically initiate 358 the above-described shredding process on application stack 302. Therefore, hypervisor 234, virtual machine 236, virtualized storage 304, and physical storage 306 may all be shredded, including the user application(s), the operating system (OS) bytecode, the configuration data, the user data and/or the utilities that are executed by and/or stored on virtual machine 236 and/or virtualized storage 304 (respectively).

### Failure to Authenticate with a Host

Again, virtualized space 300 and/or application stack 302 may be effectuated via a host (e.g., virtualization system 232), examples of which may include but are not limited to a virtualization appliance. Various authentication procedures may be periodically performed to ensure that the host (e.g., virtualization system 232) and virtualized space 300 and/or application stack 302 are properly matched. Examples of such authentication methods may include but are not limited to private key/public key encryption and digital signatures. Security process 240 may periodically check to authenticate the host (e.g., virtualization system 232) with virtualized space 300 and/or application stack 302.

In the event that the authentication fails more than a predefined number of times, this may be indicative of virtualized space 300 and/or application stack 302 being compromised (e.g., stolen and copied onto an unauthorized system and/or removed or isolated from authorized external hardware and systems).

Accordingly and in such a situation, security trigger event 242 may be generated and security process 240 may automatically initiate 358 the above-described shredding process on application stack 302. Therefore, hypervisor 234, virtual machine 236, virtualized storage 304, and physical storage 306 may all be shredded, including the user application(s), the operating system (OS) bytecode, the configuration data, the user data and/or the utilities that are executed by and/or stored on virtual machine 236 and/or virtualized storage 304 (respectively).

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

1. A computer-implemented method, executed on a computing system, comprising:
receiving a request from a user for a virtualized space, wherein the virtualized space includes a database application and a defined quantity of storage;
generating, in response to receiving the request from the user, an application stack for use within the virtualized space that includes the database application and the defined quantity of storage requested by the user, wherein the application stack further includes at least a virtual machine, physical storage, and virtual storage components;
maintaining the application stack for use within the virtualized space;
determining if one or more security trigger events have occurred, wherein the one or more security trigger events include one or more of:
a failure of a heartbeat signal to be received within the virtualized space at one or more predefined intervals; and
a failure of a host of the virtualized space to be included on a whitelist of hosts; and
effectuating a shredding process on the application stack in response to, at least in part, determining one or more security trigger events have occurred, wherein effectuating the shredding process on the application stack includes overwriting data located within the components of the application stack multiple times.

2. The computer-implemented method of claim 1 wherein the application stack further includes one or more of:
a virtual machine operating environment;
user applications;
OS bytecode;
configuration data;
user data; and
utilities.

3. The computer-implemented method of claim 1 wherein the shredding process is effectuated in response to, at least in part, a manual command.

4. (canceled)

5. The computer-implemented method of claim 3 wherein the one or more security trigger events further include:
a changing of a unique identifier associated with a host of the virtualized space.

6. (canceled)

7. The computer-implemented method of claim 3 wherein the one or more security trigger events further include:
a failure to authenticate with a host of the virtualized space.

8. A computer program product residing on a non-transitory computer readable medium having a plurality of instructions stored thereon which, when executed by a processor, cause the processor to perform operations comprising:
receiving a request from a user for a virtualized space, wherein the virtualized space includes a database application and a defined quantity of storage;
generating, in response to receiving the request from the user, an application stack for use within the virtualized space that includes the database application and the defined quantity of storage requested by the user, wherein the application stack further includes at least a virtual machine, physical storage, and virtual storage components;
maintaining the application stack for use within the virtualized space;
determining if one or more security trigger events have occurred, wherein the one or more security trigger events include one or more of:
a failure of a heartbeat signal to be received within the virtualized space at one or more predefined intervals; and
a failure of a host of the virtualized space to be included on a whitelist of hosts; and
effectuating a shredding process on the application stack in response to, at least in part, determining one or more security trigger events have occurred, wherein effectuating the shredding process on the application stack includes overwriting data located within the components of the application stack multiple times.

9. The computer program product of claim 8 wherein the application stack further includes one or more of:
a virtual machine operating environment;
user applications;
OS bytecode;
configuration data;
user data; and
utilities.

10. The computer program product of claim 8 wherein the shredding process is effectuated in response to, at least in part, a manual command.

11. (canceled)

12. The computer program product of claim 10 wherein the one or more security trigger events further include:
a changing of a unique identifier associated with a host of the virtualized space.

13. (canceled)

14. The computer program product of claim 10 wherein the one or more security trigger events further include:
a failure to authenticate with a host of the virtualized space.

15. A computing system including a processor and memory configured to perform operations comprising:
receiving a request from a user for a virtualized space, wherein the virtualized space includes a database application and a defined quantity of storage;
generating, in response to receiving the request from the user, an application stack for use within the virtualized space that includes the database application and the defined quantity of storage requested by the user, wherein the application stack further includes at least a virtual machine, physical storage, and virtual storage components;
maintaining the application stack for use within the virtualized space;
determining if one or more security trigger events have occurred, wherein the one or more security trigger events include one or more of:
a failure of a heartbeat signal to be received within the virtualized space at one or more predefined intervals; and
a failure of a host of the virtualized space to be included on a whitelist of hosts; and
effectuating a shredding process on the application stack in response to, at least in part, determining one or more security trigger events have occurred, wherein effectuating the shredding process on the application stack includes overwriting data located within the components of the application stack multiple times.

16. The computing system of claim 15 wherein the application stack further includes one or more of:
a virtual machine operating environment;
user applications;
OS bytecode;
configuration data;
user data; and
utilities.

17. The computing system of claim 15 wherein the shredding process is effectuated in response to, at least in part, a manual command.

18. (canceled)

19. The computing system of claim 17 wherein the one or more security trigger events further include:
a changing of a unique identifier associated with a host of the virtualized space.

20. (canceled)

21. The computing system of claim 17 wherein the one or more security trigger events further include:
a failure to authenticate with a host of the virtualized space.

22. The computer-implemented method of claim 7, wherein authenticating with a host of the virtualized space includes a utilizing a private key or public key encryption authentication method.

23. The computer-implemented method of claim 7, wherein authenticating with a host of the virtualized space includes utilizing a digital signature authentication method.

24. The computer-implemented method of claim 1, wherein the physical storage included within the applications stack includes a first data array coupled to a first storage processor.

25. The computer-implemented method of claim 24, wherein the first data array is coupled to the first storage processor via a fiber channel network.

26. The computer-implemented method of claim 24, wherein the first data array is coupled to the first storage processor via an InfiniBand network.
